(19) United States
(12) Patent Application Publication
(10) Pub. No.: US 2009/0297349 A1
(43) Pub. Date: Dec. 3, 2009

(54) H-shaped Vertical Axis Type Windmill Structure

(76) Inventors: Ming-Kuo Chen, Taipei County (TW); Allen Hsieh, Taipei County (TW); Jacken Chen, Taipei County (TW); Jason Kao, Taipei County (TW)

Correspondence Address: Dr. BANGER SHIA, 102 Lindencrest Ct., Sugar Land, TX, 77479-5201, US

(21) Appl. No.: 12/128,822

(22) Filed: May 29, 2008

(51) Int. Cl. F03D 3/00; F04D 29/046

(52) U.S. Cl. 416/174; 416/223 R

(57) ABSTRACT

An H-shaped vertical axis type windmill structure comprises a mainshaft on the top end of which is disposed a rotary shaft by a bearing. On the top and lower ends of the rotary shaft are disposed a support bracket and a support base, and in the middle of the rotary shaft is a connecting member. The support bracket, support base and the connecting member are connected to the connecting arms, and the other ends of the connecting arms are fixed to vertical blades. The connecting arms enable the blades to be vertically connected with the rotary shaft, and the mainshaft is not rotatable and serves as a stator of the generator structure. The vertically arranged straight and flat blades are easy to manufacture and fabricate and can be made of composite material for purpose of lightweight.

### BACKGROUND OF THE INVENTION

1. Field of the Invention

The present invention relates to an H-shaped vertical axis type windmill structure which is a combined structure of a wind generator and its drive device, and more particularly to an H-shaped vertical axis type windmill whose blades are maintained in a vertical and straight state.

2. Description of the Prior Art

Windmills are generally divided into vertical type and horizontal type according to their blades' arrangement. The horizontal type, for example, is the helicopter airfoil like windmill which is often seen in Taiwan, the generator of this type of windmill is horizontally arranged, and its blades are vertically arranged in the same way as the helicopter airfoil. The vertical windmill includes Darrieus and Savonius types, and the generator of the vertical windmill is vertically arranged. The applicant of the application has made an improvement to the Darrieus windmill in his earlier TW Pt No. M310590 “improved mainshaft of a vertical axis type windmill”, wherein a bearing is disposed between the inner and outer shafts, and Darrieus type blades are mounted on both ends of the outer shaft and Savonius type blades are mounted in the center thereof. However, since Darrieus and Savonius type blades are complicated in structure and designed to have a curvature, the structure of the mold for producing such types of blades will also be complicated and the resultant mold cost will be high.

The present invention has arisen to mitigate and/or obviate the afore-described disadvantages.

### SUMMARY OF THE INVENTION

The primary objective of the present invention is to provide a H-shaped vertical axis type windmill which comprises rotary shaft, connecting arms and vertical blades which are assembled together to form a H-shaped windmill structure, with such a design, the blades can be of flat and straight shape, so as to achieve the purpose of easy manufacture and fabrication, low production cost, and high strength.

Another objective of the present invention is to provide an H-shaped vertical axis type windmill, with the arrangement of a connecting member, a support base and a support bracket that have different elevation angles between the connecting arms connected with the blades and the rotary shaft, different sized blades, no matter large, middle or small, all can be effectively supported. Therefore, different shaped and sized windmill structures can be assembled, improving the applicability of the present invention.

Yet another objective of the present invention is to provide an H-shaped vertical axis type windmill, wherein the mainshaft received in the rotary shaft cooperates with a bearing to ensure the smooth rotation of the rotary shaft with respect to the mainshaft, and cooperates with the generator to ensure effective operation. Furthermore, since the vertically arranged blades reduce the unnecessary deviation during rotation, so that the frication damage caused by inappropriate deviation of the blades can be reduced. The high stability of rotation effectively prolongs the service life of the windmill.

### BRIEF DESCRIPTION OF THE DRAWINGS

FIG. 1 is a perspective view of an H-shaped vertical axis type windmill structure in accordance with an embodiment of the present invention;

FIG. 2 is an amplified view of the main shaft and the cover of the H-shaped vertical axis type windmill structure in accordance with the first embodiment of the present invention;

FIG. 3 is an amplified view of the main shaft and the support base of the H-shaped vertical axis type windmill structure in accordance with the first embodiment of the present invention;

FIG. 4 is an exploded view of the H-shaped vertical axis type windmill structure in accordance with the first embodiment of the present invention;

FIG. 5 is an assembly view of the H-shaped vertical axis type windmill structure in accordance with the first embodiment of the present invention;

FIG. 6 is a perspective view of an H-shaped vertical axis type windmill structure in accordance with a second embodiment of the present invention;

FIG. 7 is an amplified view of the main shaft and the cover of the H-shaped vertical axis type windmill structure in accordance with the second embodiment of the present invention; and

FIG. 8 is an amplified view of the main shaft and the support base of the H-shaped vertical axis type windmill structure in accordance with the second embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

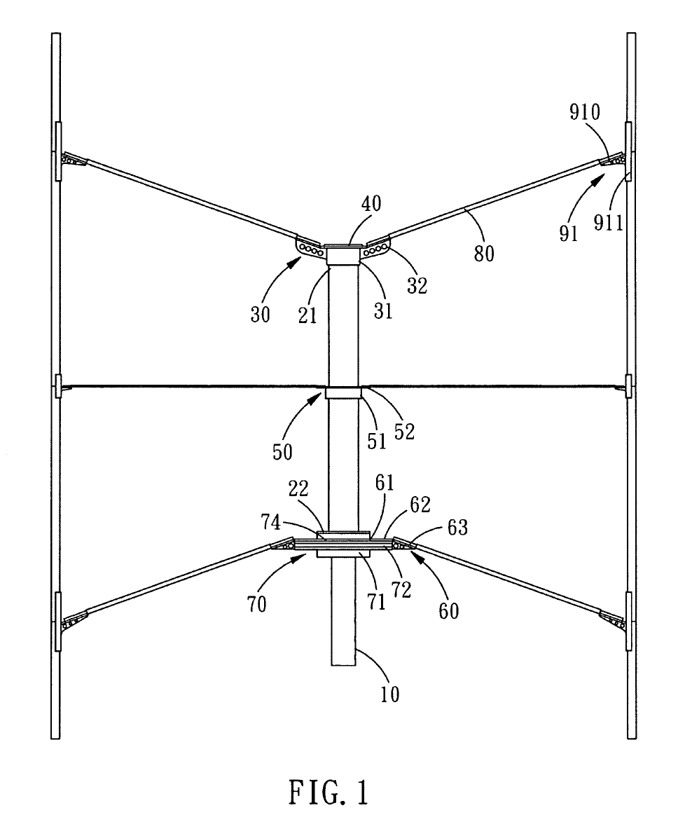

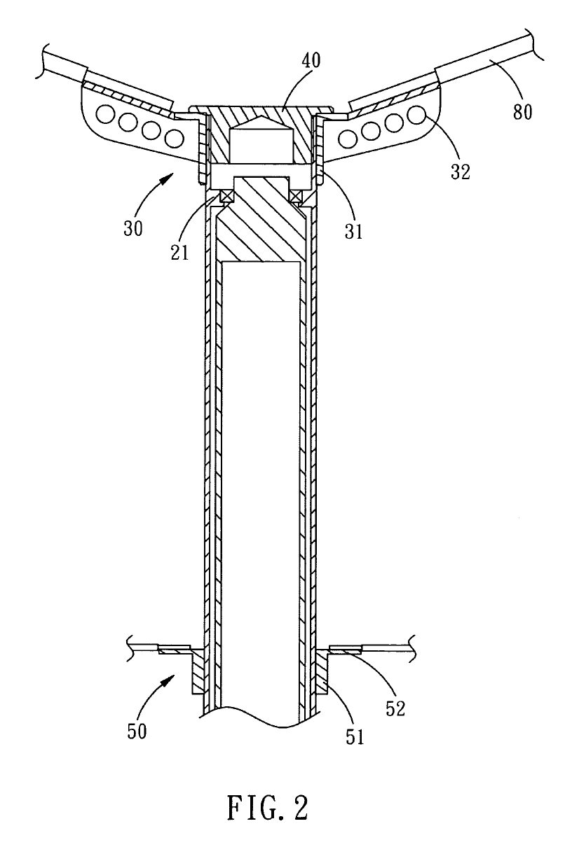

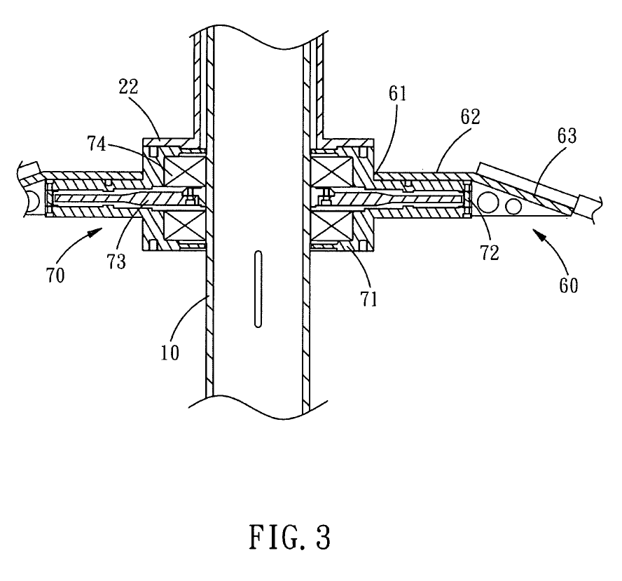

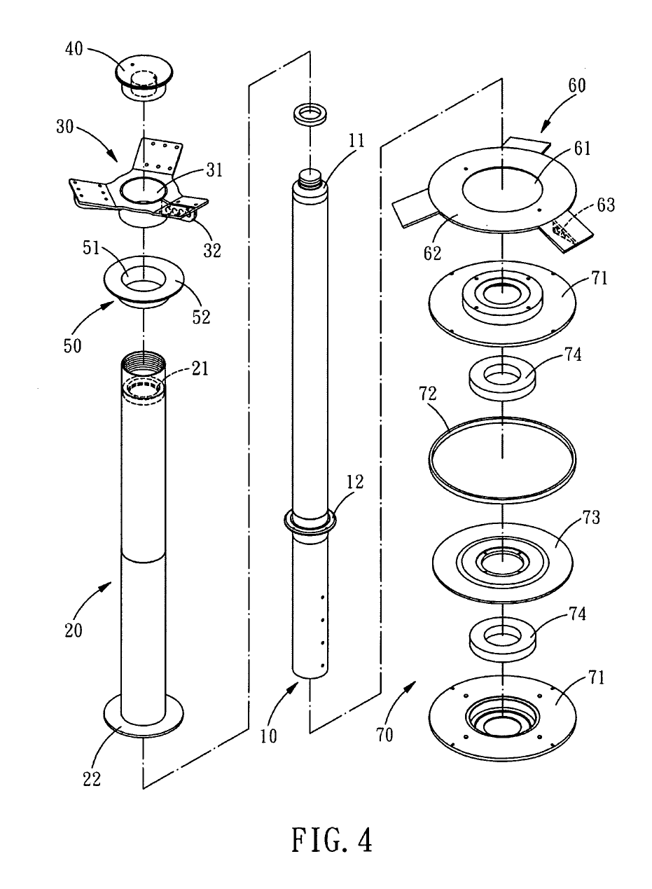

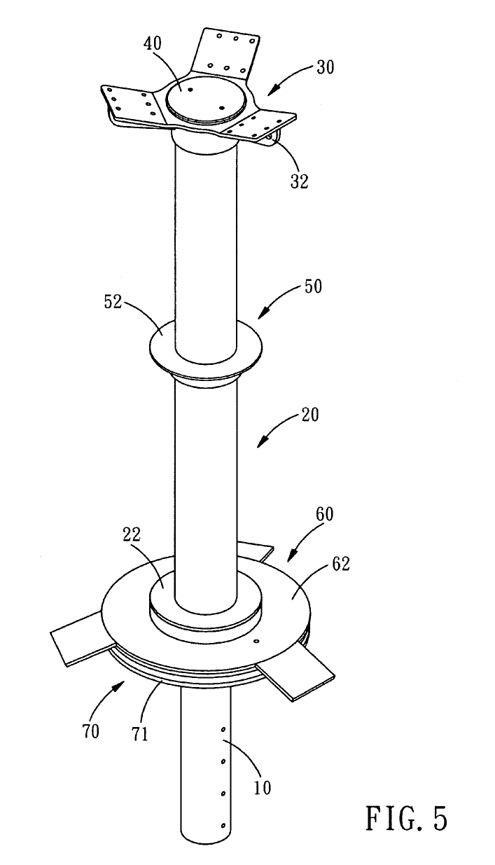

Referring to FIGS. 1-5, a H-shaped vertical axis type windmill structure in accordance with a preferred embodiment of the present invention is shown and comprises a stationary mainshaft 10 on the top end of which is disposed a rotary shaft 20, and on the top end of the rotary shaft 20 is disposed a support bracket 30 in the form of a multi-branched structure. The center of the support bracket 30 is covered with a cover 40. A multi-branched connecting member 50 is mounted on the middle of the rotary shaft 20, and a multi-branched support base 60 is disposed at the bottom of the rotary shaft 20. Between the support base 60 and the mainshaft 10 is disposed a bearing assembly 70 for cooperating with bearing structures between the mainshaft 10 and the rotary shaft 20 to allow the rotary shaft 20 to rotate stably on the mainshaft 10. The support bracket 30, the connecting member 50 and the support base 60 have the same number of branches and have the same number of connecting arms 80 connected to one end of the their respective branches, and the other end of the respective connecting arms 80 are connected to the vertical blades 90 to form a H-shaped windmill structure.

The mainshaft 10 has a conical top end 11 for pivotally connecting with the top of the rotary shaft 20, and the middle portion of the mainshaft 10 is annularly formed with a separating portion 12 in the form of a flange on which the bearing assembly 70 is disposed.

The rotary shaft 20 is a hollow cylinder for accommodation of the mainshaft 10, on the inner wall of the rotary shaft 20 and close to the top end thereof is formed a bearing portion 21 in the form of an inner flange for positioning the bearing on the top end of the mainshaft 10. The support bracket 30 is disposed on the outside of the top end of the rotary shaft 20. The bottom of the rotary shaft 20 extends outward to form a linking portion 22 in the form of an outer flange in which are defined through holes for cooperating with bolts to fix the support base 60, so that the support base 60 and the rotary shaft 20 can be driven by the blades 90 to rotate synchronously through the connecting arms 80.

The support bracket 30 is of a trifurcated shape with a central engaging portion 31 in the form of a through hole for engaging with the top end of the rotary shaft 20, and three platform-type connecting portions 32 with an elevation angle are equidistantly arranged and extended outward from the engaging portion 31. On each of the connecting portions 32 are formed through holes for cooperating with bolts to fix the connecting arms 80.

The cover 40 with a concave portion toward the mainshaft 10 is disposed in the center of the support bracket 30, and around the top periphery of the cover 40 is defined a flange which enables the cover 40 to be engaged against the outer periphery of the top end of the rotary shaft 20 so as to seal the top open end of the rotary shaft 20 and to effectively prevent the slide or disengagement of the support bracket 30.

The connecting member 50 is defined in its center thereof with an inserting portion 51 in the form of a through hole, and a platform type connecting portion 52 is equally extended outward from the outer periphery of the inserting portion 51 and cooperates with bolts to fix the connecting arms 80.

The support base 60 is a trifurcate structure with a central engaging portion 61 in the form of a through hole for engaging with the bottom of the rotary shaft 20 and horizontally extends outward from the engaging portion 61 to form a linking portion 62 in the form of a circular disc which is defined with fixing holes so that the support base 60 and the bearing assembly 70 can be fixed to each other by bolts and are rotatable together. Three platform-type connecting portions 63 with an elevation angle are equidistantly arranged and extended outward from the outer periphery of the linking portion 62. On each of the connecting portions 63 are formed through holes for cooperating with bolts to fix the connecting arms 80.

The bearing assembly 70 includes two oppositely arranged T-shaped covers 71. Between the outermost portions of the two covers 71 is disposed a ring 72, and in the space defined by the ring 72 is disposed a circular and flat separator 73. Each of the covers 71 has a bearing 74 received in its concave portion. The two bearings 74 are positioned against both sides of the separating portion 12 of the mainshaft 10 and are fixed to the linking portion 62 by bolts so as to be rotatable together with the support base 60.

The connecting arms 80 are laminal members both ends of which are defined with a through hole for enabling the connecting arms 80 to be fixed to relative structures by bolts.

The blades 90 are vertically arranged and provided with reverse T-shaped connecting elements 91 for connecting the connecting arms 80, and each of the connecting elements 91 is defined with a vertically arranged blade-fixing portion 910 and an arm-fixing portion 911 which is inclined in accordance with the inclination of the respective connecting arms 80. The connecting elements 91 are also defined with through holes for fixing or connecting purpose by cooperation with bolts.

With the abovementioned arrangements, the present invention has the following advantages:

First, forming a H-shaped structure with high stability: the blades 90, the connecting arms 80 and the rotary shaft 20 are assembled to form a H-shaped structure which is highly stable, simply structured and easy to fabricate. Further, since the blades 90 are straight and flat, the structure of the mold for producing the blades 90 will be simple and the resultant mold cost will be low.

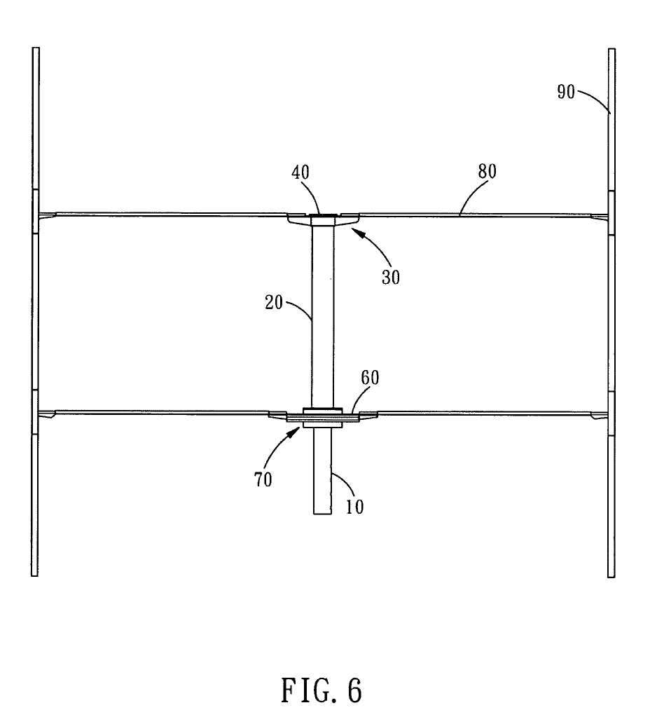

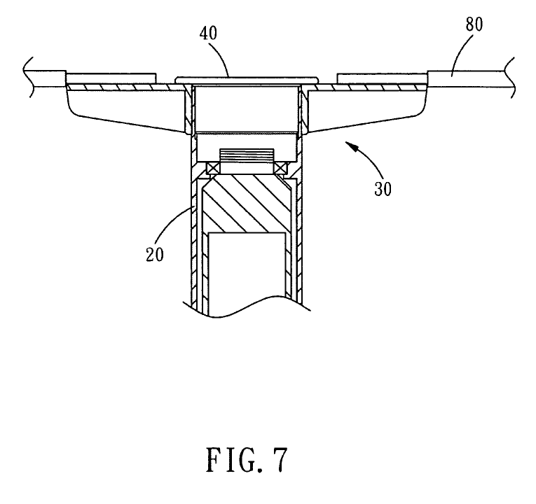

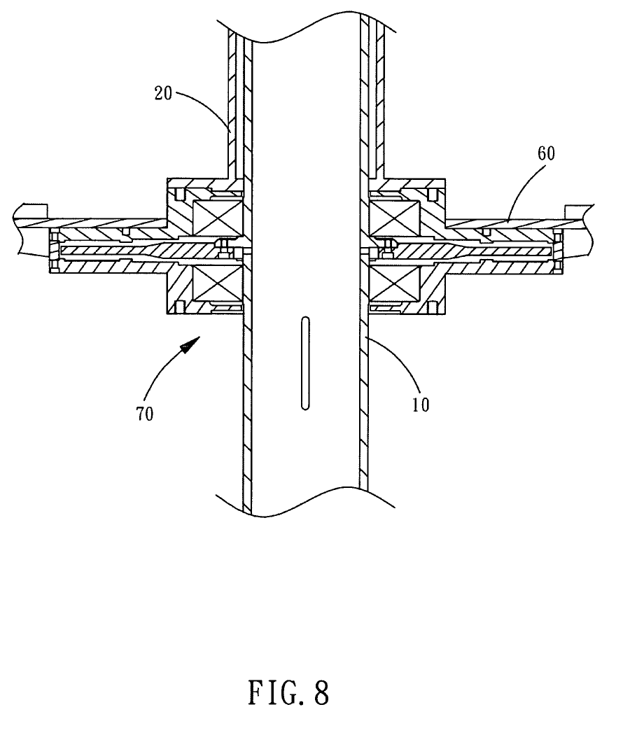

Second, versatility and high applicability: with different connecting members 50, support bases 60 and support brackets 30, different number of connecting arms 80 and blades 90 can be assembled to form different types of windmill structures. In addition to the embodiment as shown in the previous figures, the present invention can also have different embodiment as shown in FIGS. 6-8, wherein it doesn't need to arrange connecting member 50 on the outer periphery of the rotary shaft 20, and the connecting arms 80 for cooperating with the connecting member 50 can also be omitted. The blades 90 of this embodiment are shorter than those of the previous embodiment. Hence, a different windmill structure is formed to meet different consumer's requirements.

Third, stable rotation: since the blades 90 are vertically arranged, it won't produce wind pressure within the rotation scope of the blades 90. Further, the top and lower ends of the windmill are open, so that if any wind pressure is caused by the blades 90, it can be discharged from the top and lower ends of the windmill, thus reducing the unnecessary wind disturbance during rotation. With the bearing assembly 70 and the vertically arranged blades 90 are less likely to be deviated during rotation, so that the frication damage caused by inappropriate deviation of the blades 90 can be reduced. The high stability of rotation effectively prolongs the service life of the windmill.

While we have shown and described various embodiments in accordance with the present invention, it is clear to those skilled in the art that further embodiments may be made without departing from the scope of the present invention.

What is claimed is:

1. A H-shaped vertical axis type windmill structure comprising:
a mainshaft;
a rotary shaft pivotally mounted on an outer periphery of the mainshaft, at least one bear disposed between the mainshaft and the rotary shaft;
a support bracket mounted on a top end of the rotary shaft;
a support base mounted at a bottom of the rotary shaft, at least one bearing assembly disposed between the support base and the mainshaft, wherein the support bracket and the support base are a multi-branched structure and have the same number of branches;
a plurality of connecting arms with one end fixed to the support bracket and the support base;
a plurality of blades vertically arranged around a periphery of the windmill and connected to the other end of the respective connecting arms.

2. The H-shaped vertical axis type windmill structure as claimed in claim 1, wherein a connecting member is a multi-branched structure mounted on an outer periphery of the rotary shaft to cooperate with the support bracket and the support base to connect the connecting arms, and the other end of the respective connecting arms is connected to the blades.

3. The H-shaped vertical axis type windmill structure as claimed in claim 1, wherein the mainshaft has a conical top end for pivotally connecting with a top of the rotary shaft, and a middle portion of the mainshaft is annularly formed with a separating portion in the form of a flange on which the bearing assembly is disposed.

4. The H-shaped vertical axis type windmill structure as claimed in claim 1, wherein the rotary shaft is a hollow cylinder for accommodation of the mainshaft, on an inner wall of the rotary shaft and close to a top end thereof is formed a bearing portion in the form of an inner flange for positioning the bearing on a top end of the mainshaft, the support bracket is disposed on an outside of the top end of the rotary shaft, the bottom of the rotary shaft extends outward to form a linking portion in the form of an outer flange in which are defined through holes for cooperating with bolts to fix the support bracket.

5. The H-shaped vertical axis type windmill structure as claimed in claim 1, wherein the support bracket is of a trifurcated shape with a central engaging portion in the form of a central hole for engaging with the top end of the rotary shaft, and three platform-type connecting portions with an elevation angle are equidistantly arranged and extended outward from the engaging portion, in each of the connecting portions are formed through holes for cooperating with bolts to fix the connecting arms.

6. The H-shaped vertical axis type windmill structure as claimed in claim 1, wherein a cover with a concave portion toward the mainshaft is disposed in a center of the support bracket, and around a top periphery of the cover is defined a flange.

7. The H-shaped vertical axis type windmill structure as claimed in claim 1, wherein a connecting member is mounted on an outer periphery of the rotary shaft, the connecting member is defined in its center thereof with an inserting portion in the form of a through hole, and a platform type connecting portion is equally extended outward from an outer periphery of the inserting portion and cooperates with bolts to fix the connecting arms.

8. The H-shaped vertical axis type windmill structure as claimed in claim 2, wherein the connecting member is defined in its center thereof with an inserting portion in the form of a through hole, and a platform type connecting portion is equally extended outward from an outer periphery of the inserting portion and cooperates with bolts to fix the connecting arms.

9. The H-shaped vertical axis type windmill structure as claimed in claim 1, wherein the support base is a trifurcate structure with a central engaging portion in the form of a through hole for engaging with the bottom of the rotary shaft and horizontally extends outward from the engaging portion to form a linking portion in the form of a circular disc which is defined with fixing holes so that the support base and the bearing assembly are rotatably fixed together by bolts, three platform-type connecting portions with an elevation angle are equidistantly arranged and extended outward from an outer periphery of the linking portion, in each of the connecting portions are formed through holes for cooperating with bolts to fix the connecting arms.

10. The H-shaped vertical axis type windmill structure as claimed in claim 1, wherein the bearing assembly includes two oppositely arranged T-shaped covers, between outermost portions of the two covers is disposed a ring, and in a space defined by the ring is disposed a circular and flat separator, each of the covers has a bearing received in its concave portion, the two bearings are positioned against both sides of a separating portion of the mainshaft and are fixed to the supporting base by bolts.

11. The H-shaped vertical axis type windmill structure as claimed in claim 1, wherein the connecting arms are laminal members both ends of which are defined with a through hole for enabling the connecting arms to be fixed to relative structures by bolts.

12. The H-shaped vertical axis type windmill structure as claimed in claim 1, wherein the blades are vertically arranged and provided with reverse T-shaped connecting elements for connecting the connecting arms, and each of the connecting elements is defined with a vertically arranged blade-fixing portion and an arm-fixing portion which is inclined in accordance with an inclination of the respective connecting arms, the connecting elements are defined with through holes for fixing the connecting arms by cooperation with bolts.
